(19) United States
(12) Patent Application Publication
(10) Pub. No.: US 2019/0375609 A1
(43) Pub. Date: Dec. 12, 2019

(54) INFORMATION PROCESSING DEVICE, INFORMATION PROCESSING METHOD, AND INFORMATION PROCESSING SYSTEM

(71) Applicant: Sony Mobile Communications Inc., Tokyo (JP)

(72) Inventors: Satoshi HOSOKAWA, Tokyo (JP); Takanori KUBOTA, Tokyo (JP); Noriaki TAIRA, Tokyo (JP); Takuro JOJU, Tokyo (JP)

(73) Assignee: Sony Mobile Communications Inc., Tokyo (JP)

(21) Appl. No.: 16/478,854

(22) PCT Filed: Dec. 6, 2017
(86) PCT No.: PCT/JP2017/043846

§ 371 Date: Jul. 18, 2019

(30) Foreign Application Priority Data
Mar. 29, 2017 (JP) 2017-065276

(51) Int. Cl. B66B 1/34; B66B 1/14; G07C 9/00

(52) U.S. Cl. CPC B66B 1/3453; B66B 1/14; B66B 2201/211; G07C 9/00063; B66B 2201/214; B66B 1/3407

(57) ABSTRACT

The present disclosure provides an information processing device, an information processing method, and an information processing system capable of improving convenience of use of a moving object on a route according to schedule information of a user.

An information processing device includes a control unit that determines whether or not a moving object is used on a route to a destination calculated on the basis of a current position and closest schedule information of a user and performs control to move the moving object used on the route to a riding place of the user.

### TECHNICAL FIELD

The present disclosure relates to an information processing device, an information processing method, and an information processing system.

### BACKGROUND ART

Conventionally, various technologies for controlling an elevator have been proposed.

For example, Patent Document 1 discloses an elevator group management system that acquires information regarding the number of led persons and routes registered in advance in an IC card by an operation of an operator by a card reader installed at a riding place and controls a call of an elevator and a travel to a destination floor on the basis of the information regarding the number of led people and the routes. With this elevator group management system, it is possible to register all destination floors only by holding up the IC card over the card reader of the riding place by a user without registering a destination floor in the riding place or the elevator.

### CITATION LIST

### Patent Document

### Patent Document 1: Japanese Patent Application Laid-Open No. 2005-219840

### SUMMARY OF THE INVENTION

### Problems to be Solved by the Invention

However, a technology described in Patent Document 1 is assumed to be used when a leading person or a guiding person carrying an IC card leads and guides a plurality of persons along a predetermined route, such that it is not performed to continuously determine the destination in real time in consideration of a current position or schedule information of each individual to control the elevator on the route.

Therefore, the present disclosure proposes an information processing device, an information processing method, and an information processing system capable of improving convenience of use of a moving object on a route according to schedule information of a user.

### Solutions to Problems

According to the present disclosure, there is proposed an information processing device including a control unit that determines whether or not a moving object is used on a route to a destination calculated on the basis of a current position and closest schedule information of a user and performs control to move the moving object used on the route to a riding place of the user.

According to the present disclosure, there is proposed an information processing method including performed by processor, the information processing method including: determining whether or not a moving object is used on a route to a destination calculated on the basis of a current position and closest schedule information of a user; and performing control to move the moving object used on the route to a riding place of the user.

According to the present disclosure, there is proposed an information processing system including: a server that includes a control unit that determines whether or not a moving object is used on a route to a destination calculated on the basis of a current position and closest schedule information of a user and performs control to move the moving object used on the route to a riding place of the user; and a terminal device that is worn by the user and includes a route calculation unit that calculates the route from the current position to the destination on the basis of the current position and the closest schedule information of the user, in which the server further includes a reception unit that receives the calculated route information from the terminal device, and the control unit determines whether or not the moving object is used on the route to the destination indicated by the route information.

### Effects of the Invention

As described above, according to the present disclosure, it is possible to improve convenience of use of the moving object on the route according to the schedule information of the user.

Note that the effect described above is not necessarily restrictive, and any effect set forth in the present specification or other effects that can be grasped from the present specification may be accomplished together with or instead of the effect described above.

### BRIEF DESCRIPTION OF DRAWINGS

FIG. 1 is a view for describing an overview of an information processing system according to an embodiment of the present disclosure.

FIG. 2 is a view for describing a case where a display area is partially provided in a card type terminal of the present embodiment.

FIG. 3 is a block diagram illustrating an example of a configuration of the card type terminal according to the present embodiment.

FIG. 4 is a view for describing switching of an operation mode according to the present embodiment.

FIG. 5 is a block diagram illustrating an example of a configuration of a management server according to the present embodiment.

FIG. 6 is a flowchart illustrating operation mode switching processing according to the present embodiment.

FIG. 7 is a view illustrating an example of the entire configuration of a navigation system including a moving object control according to the present embodiment.

FIG. 8 is a block diagram illustrating an example of a configuration of a card type terminal used in the navigation system according to the present embodiment.

FIG. 9 is a flowchart illustrating operation processing of the navigation system according to the present embodiment.

FIG. 10 is a view illustrating an example of a route guidance screen according to the present embodiment.

FIG. 11 is a view for describing another guidance method using the card type terminal according to the present embodiment.

FIG. 12 is a view for describing an elevator call button attachment according to the present embodiment.

### MODE FOR CARRYING OUT THE INVENTION

Hereinafter, preferred embodiments of the present disclosure will be described in detail with reference to the accompanying drawings. Note that in the present specification and the drawings, components having substantially the same functional configuration will be denoted by the same reference numerals and an overlapping description will be omitted.

Furthermore, a description will be given in the following order.

1. Overview of Information Processing System According to Embodiment of the Present Disclosure

2. Configuration

2-1. Configuration of Card Type Terminal 2

2-2. Configuration of Management Server 3

3. Operation Processing

4. Navigation System

4-1. Entire Configuration

4-2. Configuration of Card Type Terminal 2b

4-3. Operation Processing

4-4. Supplement

### 5. SUMMARY

### 1. Overview of Information Processing System According to Embodiment of the Present Disclosure

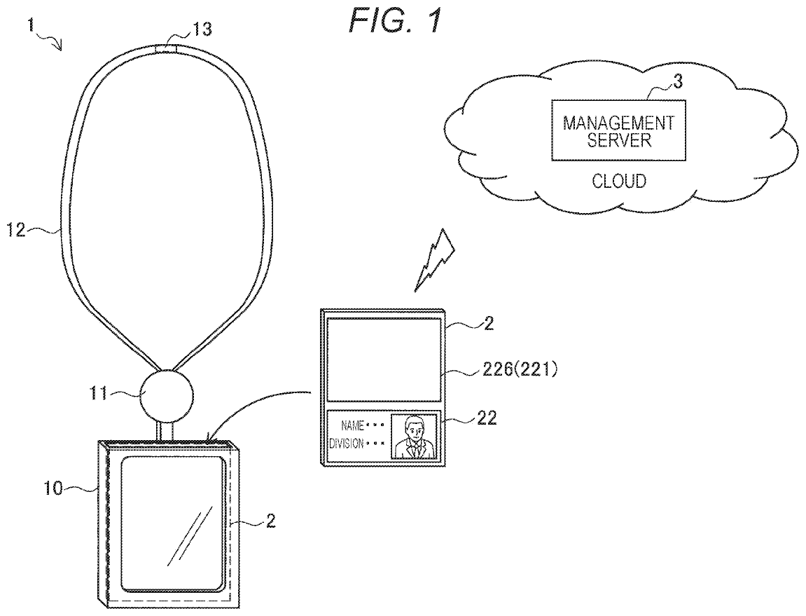

FIG. 1 is a view for describing an overview of an information processing system according to an embodiment of the present disclosure. As illustrated in FIG. 1, the information processing system according to the present embodiment includes a card type terminal 2 worn by a user and a management server 3, and the card type terminal 2 and the management server 3 are connected to each other by wireless communication to transmit and receive data to and from each other.

The card type terminal 2 is attachable to or removable from a neck strap device 1, for example, as illustrated in FIG. 1, and the user can wear the card type terminal 2 using the neck strap device 1. For example, it is assumed that the card type terminal 2 is used as an employee ID card in an office.

Furthermore, a display unit 226 is provided in the card type terminal 2 according to the present embodiment. The display unit 226 functions as a notification area for notifying the user of various types of information. For example, on the display unit 226, a schedule (schedule information) of the user, an email, route guidance (for example, guidance to the next conference room, or the like), a display of a place of a person who the user is searching for (person searching function in which a position of a search target person is displayed on a map in the office), information regarding the other party that is on the phone, and the like, are given as notification.

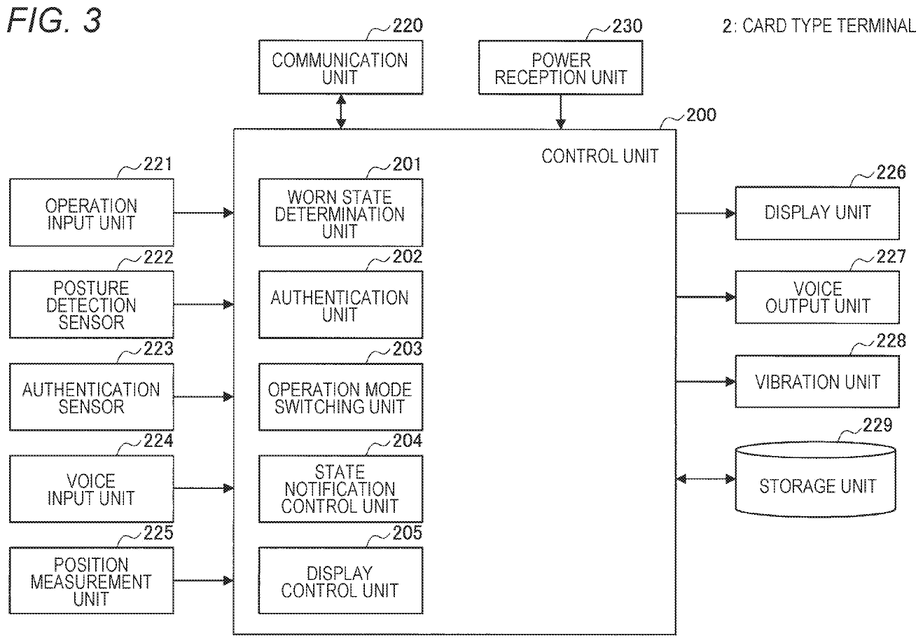

Furthermore, the card type terminal 2 is provided with a position measurement unit 225 (see FIG. 3) to continuously transmit current position information to the management server 3. Therefore, on the management server 3 side, it is possible to manage where anybody is in real time. Therefore, for example, when using the person search function, the user inputs a name or the like of a person who he/she wants to search for into the card type terminal 2 to transmit a request to the management server 3, and the management server 3 searches for a current position of the person, generates a display image showing a location on the map in the office, and sends the display image back to the card type terminal 2.

Furthermore, the card type terminal 2 may have a call function. For example, a voice call may be made using a microphone and a speaker provided on the card type terminal 2, and utterance of the user may be collected by the microphone provided on the card type terminal 2 and a voice of the other user may be converted into a text and then displayed on the display unit 226.

Furthermore, the display unit 226 may be realized by a touch panel display including a touch sensor, which is an example of an operation input unit 221. The user can input an operation on a screen displayed on the display unit 226 by a touch operation.

Furthermore, the card type terminal 2 may be further provided with a fixed information display area 22, in addition to the notification area realized by the display unit 226. For example, a user's name or division information, a face image, and the like are always displayed on the fixed information display area 22. The reason is that it is desirable that the user's name or division information, the face image, and the like are always displayed, particularly in a case where the card type terminal 2 is also used as the employee ID card. The fixed information display area 22 is realized by a display or a printed matter.

Furthermore, the card type terminal 2 is provided with a posture detection sensor 222 (see FIG. 3), and a display direction of the display unit 226 is reversed depending on a posture (vertical direction) of the card.

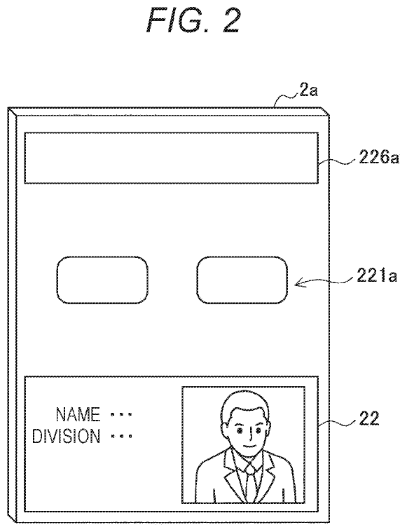

In the card type terminal 2 described above, as illustrated in FIG. 1, almost the entire area on the front of the card is a display area, but the present embodiment is not limited thereto. For example, a display area may be partially provided like a one-line display or the like. Here, a card type terminal 2a in which the display area is partially provided will be described with reference to FIG. 2.

As illustrated in FIG. 2, the card type terminal 2a is provided with a display unit 226a having a size capable of displaying at least one line of text, an operation input unit 221a having a button shape, and a fixed information display area 22. The display unit 226a functions as a notification area, such that, for example, the next schedule of the user, a title (or a sender) of a received email, a place or a direction (for example, “second floor, 2011 conference room”, “right of the next corner”, or the like) of the next conference room, a display (for example, “3012 conference room”, “third floor”, “being out”, or the like) of a place of the person who the user is searching for, and information (for example, name, division or the like) regarding the other party that is on the phone are displayed.

The operation input unit 221a having the button shape may be a button having a physical structure or may be a touch panel. For example, a notification content displayed on the display unit 226a can be switched by an operation of the operation input unit 221a.

The card type terminal 2 described above is an example of a terminal device carried by the user, but a shape of the card type terminal 2 is not limited to a card type, and may be another shape. Furthermore, the terminal device may be realized by a smartphone, a mobile phone terminal, a tablet terminal, a wearable device (for example, a smartband, a smartwatch, or a smarteyeglass), or the like.

The neck strap device 1 to or from which the card type terminal 2 is attached or removed includes a strap unit 12, a connection unit 11, and a card holder unit 10 as illustrated in FIG. 1. The strap unit 12 and the connection unit 11 may be provided with an expansion battery. Furthermore, the strap unit 12 is provided with a proximity sensor 13 that detects that the strap unit 12 is hung on a neck of the user. The proximity sensor 13 is a sensor that acquires a separation distance between the user and the strap unit 12, and is realized by, for example, an inductive sensor, a capacitive sensor, an ultrasonic sensor, or an infrared sensor.

The card holder unit 10 is suspended from the connection unit 11 mounted on the strap unit 12, and stores the card type terminal 2. A method of storing the card type terminal is not particularly limited, but may be, for example, a slide shape in which the card type terminal 2 is inserted from above, as illustrated in FIG. 1. Furthermore, a front surface of the card holder unit 10 includes a transparent member or is formed to be opened so that the display area of the stored card type terminal 2 is visible from the outside.

Moreover, the card holder unit 10 can supply power from the expansion battery provided in the strap unit 12 or the connection unit 11 to the stored card type terminal 2. The supply of the power is realized by contact or non-contact connection means (not illustrated). Specifically, for example, a contactless charging unit using electromagnetic induction is provided inside the card holder unit 10, such that the power can be supplied to the stored card type terminal 2. As described above, since the card type terminal 2 can be charged when it is stored in the card holder unit 10, even in a case where power is insufficient only with the battery (not illustrated) embedded in the card type terminal 2, the card type terminal 2 is charged when it is mounted in the card holder unit 10, such that it is possible to realize an operation of the card type terminal 2 for a long period of time.

Furthermore, the card holder unit 10 has contact or non-contact connection means for transmitting a detection result by the proximity sensor 13 provided in the strap unit 12 to the card type terminal 2. For example, the card holder unit 10 can be connected to the proximity sensor 13 provided in the strap unit 12 in a wired manner to obtain the detection result, and can further transmit the detection result to the card type terminal 2 mounted in the card holder unit 10 by short range wireless communication.

It is assumed that the card type terminal 2 described above is worn by the user in a state where it is inserted into the neck strap device 1 and the user always carries the card type terminal 2 as the employee ID card, for example, in the office. The card type terminal 2 is provided with the display unit 226 as described above and a schedule, guidance to the next conference room, and the like are displayed on the display unit 226, and convenience of the user is thus high. Furthermore, as described above, the card type terminal 2 is provided with the position measurement unit 225 (see FIG. 3), such that it is possible to measure a current position of the user.

Here, in the related art, in an elevator group management system, it has not been performed to continuously determine a destination in real time in consideration of a current position or schedule information of each individual to control an elevator.

Therefore, the information processing system according to the present embodiment can grasp the current position of the user by the card type terminal 2 described above, acquire schedule information (for example, reservation information of a conference room) of the user from the management server 3 or the like, estimate the destination, and navigate to the destination. Such navigation is triggered by the user starting to move, such that destination estimation and route calculation can be appropriately performed. Furthermore, in a case where a moving object exists on the route to the destination, the information processing system according to the present embodiment controls the moving object in advance to move to a riding place, such that convenience of the use of the moving object such as reduction of a waiting time can be further improved.

The outline of the information processing system according to the embodiment of the present disclosure has been described hereinabove. Next, specific configurations of the respective devices included in the information processing system according to the present embodiment will be described with reference to the drawings.

### 2. Configuration

### 2-1. Configuration of Card Type Terminal 2

FIG. 3 is a block diagram illustrating an example of a configuration of the card type terminal 2 according to the present embodiment. As illustrated in FIG. 3, the card type terminal 2 includes a control unit 200, a communication unit 220, an operation input unit 221, a posture detection sensor 222, an authentication sensor 223, a voice input unit 224, a position measurement unit 225, a display unit 226, a voice output unit 227, a vibration unit 228, a storage unit 229, and a power reception unit 230.

(Control Unit 200)

The control unit 200 functions as an arithmetic processing device and a control device, and generally controls an operation in the card type terminal 2 according to various programs. The control unit 200 is realized by, for example, an electronic circuit such as a central processing unit (CPU), a microprocessor or the like. Furthermore, the control unit 200 may include a read only memory (ROM) that stores programs, calculation parameters or the like that are used and a random access memory (RAM) that temporarily stores parameters or the like that are appropriately changed.

Furthermore, the control unit 200 according to the present embodiment also functions as a worn state determination unit 201, an authentication unit 202, an operation mode switching unit 203, a state notification control unit 204, and a display control unit 205.

The worn state determination unit 201 determines a worn state of the card type terminal 2 by the user. Specifically, the worn state determination unit 201 determines whether or not the card type terminal 2 is in a state in which it is worn by the user on the basis of the detection result detected by the proximity sensor 13 provided in the strap unit 12 and received from the neck strap device 1 in which the card type terminal 2 is mounted.

The authentication unit 202 performs authentication of the user himself/herself on the basis of information detected by the authentication sensor 223. For example, in a case where the authentication sensor 223 is a biometric sensor, the authentication unit 202 performs pattern matching using biometric information (specifically, fingerprint information, vein information, and the like) acquired by the authentication sensor 223 and biometric information of the user registered in advance, and determines that the user authentication has been successful in a case where a similarity is higher than a predetermined value. Note that an authentication method is not limited to the biometric information, and may be, for example, voiceprint authentication, face authentication, gesture authentication, or the like. The voiceprint authentication is performed by analyzing voice information of the user acquired using a microphone as the authentication sensor 223 (or using the voice input unit 224). Furthermore, the face authentication is performed by analyzing acquired face image information of the user using a camera as the authentication sensor 223. Furthermore, the gesture authentication is performed by analyzing movement of the user (that is, movement of the card type terminal 2) acquired by an acceleration sensor or a gyro sensor as the authentication sensor 223 using the acceleration sensor or the gyro sensor.

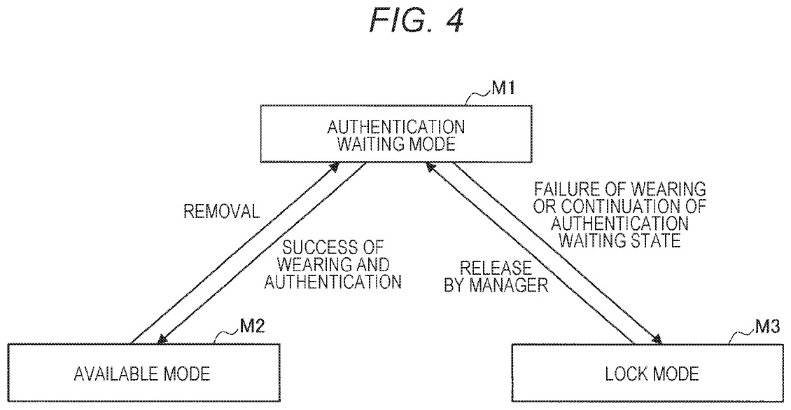

The operation mode switching unit 203 switches an operation mode of the card type terminal 2 depending on the worn state or an authentication result. Here, the switching of the operation mode according to the present embodiment will be described with reference to FIG. 4. As illustrated in FIG. 4, the operation modes of the card type terminal 2 according to the present embodiment include an authentication waiting mode M1, an available mode M2, and a lock mode M3. The authentication waiting mode M1 is a state of waiting for authentication by the user (OFF state). The available mode M2 is a state where a function of the card type terminal 2 can be used (ON state). The lock mode M3 is a state in which the card type terminal 2 is unavailable.

The switching (shift) of the operation mode is mainly controlled depending on the worn state of the card. For example, in a case where the user wears the card type terminal 2 and the authentication is successful, the operation mode is switched from the authentication waiting mode M1 to the available mode M2. Furthermore, when the card type terminal 2 is removed by the user to be in a non-worn state, the operation mode is switched to the authentication waiting mode M1. With this configuration, the available mode M2 is continued during a period in which the card type terminal 2 is worn.

On the other hand, in a case where the user authentication fails a predetermined number of times or more or in a case where the card type terminal 2 is in a non-use state (that is, the authentication waiting mode M1) for a predetermined period (time) or more, the operation mode is switched to the lock mode M3. The lock mode M3 can be released by a manager in the management server 3. When the release is performed, the operation mode is switched to the authentication waiting mode M1.

The state notification control unit 204 performs control to notify the management server 3 of the state of the card type terminal 2. For example, the state notification control unit 204 transmits a current operation mode to the management server 3 on a cloud through the communication unit 220. Furthermore, the state notification control unit 204 may continuously transmit current position information measured by the position measurement unit 225 to the management server 3.

Furthermore, when it is determined by the worn state determination unit 201 that the card type terminal 2 is in the non-worn state and it is detected by the posture detection sensor 222 (specifically, an acceleration sensor, a gyro sensor, a geomagnetic sensor, or the like) that the card type terminal 2 has fallen or the card type terminal 2 has no movement for a certain period and has been misplaced, the state notification control unit 204 notifies the management server 3 that the card type terminal 2 is in a lost state, together with the current position information. The management server 3 that has received the notification of the lost state can inform the user of the loss of the card type terminal 2 by transmitting information indicating that the card type terminal 2 is in the lost state and a lost place to a communication terminal (a smartphone, a PC, or the like) of the user who is an owner of the card type terminal 2.

The display control unit 205 controls the display unit 226 to display various types of notification information. For example, the display control unit 205 controls the display unit 226 to display schedule information (schedule) of the user acquired from the management server 3, a content of a received email, a navigation screen such as guidance to the next conference room, or the like, a map image indicating a place of a person who the user is searching for, and the like.

(Communication Unit 220)

The communication unit 220 is connected to the management server 3 on the cloud by wireless communication to transmit and receive data to and from the management server 3. The communication unit 220 is communicably connected to the cloud by, for example, a wireless local area network (LAN), Wi-Fi (registered trademark), Bluetooth (registered trademark), a mobile communication network (long term evolution (LTE), third generation mobile communication system (3G)), or the like.

Furthermore, the communication unit 220 can also receive the detection result of the proximity sensor 13 provided in the strap unit 12 from the card holder unit 10 in which the card type terminal 2 is mounted. The detection result can be received from the card holder unit 10 by contact or non-contact means. Specifically, for example, the communication unit 220 is realized by a short range wireless communication unit.

(Operation Input Unit 221)

The operation input unit 221 receives an operation instruction by the use, and outputs an operation content of the operation instruction to the control unit 200. The operation input unit 221 may be a touch sensor, a pressure sensor, or a proximity sensor (such as a capacitance sensor) provided integrally with the display unit 226. Alternatively, the operation input unit 221 may be a physical configuration provided separately from the display unit 226, such as a button, a switch and the like.

(Posture Detection Sensor 222)

The posture detection sensor 222 detects a posture of the card type terminal 2 and outputs a detection result to the control unit 200. The posture detection sensor 222 may be, for example, an acceleration sensor, a gyro sensor, and a geomagnetic sensor.

(Authentication Sensor 223)

The authentication sensor 223 is a sensor that acquires information for performing authentication of the person himself, and, may be, for example, a biometric sensor (specifically, a fingerprint sensor, a vein sensor or the like), a camera (capturing a face image or an iris image), an acceleration sensor (acquiring a gesture (motion)), short range wireless communication (acquiring authentication information from a held-up IC card or the like), or the like. In a case where the authentication sensor 223 is the fingerprint sensor, the authentication sensor 223 may be provided at a position at which it is easily touched by the user when the user holds the card, such as, for example, a side surface or a back surface of the card type terminal 2. Furthermore, the authentication sensor 223 is provided at a position where it can be detected even in a state where the card type terminal 2 is stored in the card holder unit 10. Furthermore, a part of the card holder unit 10 may be opened so that fingerprint information can be obtained even in the state where the card type terminal 2 is stored in the card holder unit 10.

(Voice Input Unit 224)

The voice input unit 224 is realized by a microphone, a microphone amplifier unit that amplifies and processes a voice signal obtained by the microphone, and an A/D converter that converts the voice signal into a digital signal, and outputs the voice signal to the control unit 200.

(Position Measurement Unit 225)

The position measurement unit 225 has a function of detecting a current position of the card type terminal 2 on the basis of an acquired signal from the outside. Specifically, for example, the position measurement unit 225 may detect the position by transmission/reception with, for example, Wi-Fi (registered trademark), Bluetooth (registered trademark), a mobile phone, a PHS, a smartphone, or the like, or short range communication or the like. For example, the position measurement unit 225 can receive Bluetooth low energy (BLE) beacons including place IDs from a plurality of transmitters installed at various places in the office and measure distances to each transmitter from reception intensities to obtain indoor positions. Furthermore, the position measurement unit 225 can also perform outdoor position measurement using a global positioning system (GPS). In other words, the position measurement unit 225 receives an electric wave from a GPS satellite, measures a position at which the card type terminal 2 exists, and outputs measured position information to the control unit 200.

(Display Unit 226)

The display unit 226 is a display device that outputs the notification information, an operation screen, a menu screen, or the like. The display unit 226 may be, for example, a display device such as a liquid crystal display (LCD), an organic electroluminescence (EL) display or the like.

(Voice Output Unit 227)

The voice output unit 227 has a speaker reproducing a voice signal and an amplifier circuit for the speaker. The voice output unit 227 can output the notification information and a voice of the other party that is on the phone.

(Vibration Unit 228)

The vibration unit 228 vibrates the card type terminal 2 to perform the notification to the user. Furthermore, the vibration unit 228 can perform the notification by a predetermined vibration pattern or can perform direction guidance.

(Storage Unit 229)

The storage unit 229 is realized by a read only memory (ROM) that stores programs, calculation parameters or the like, that are used for processing of the control unit 200 and a random access memory (RAM) that temporarily stores parameters and the like that are appropriately changed. The storage unit 229 may store schedule information of the user. Furthermore, the storage unit 229 may store information for authentication (fingerprint information of the user, or the like).

(Power Reception Unit 230)

The power reception unit 230 is a contact or non-contact connection unit that receives power from the card holder unit 10. For example, the power reception unit 230 can receive the power in a non-contact manner using electromagnetic induction.

The configuration of the card type terminal 2 according to the present embodiment has been described in detail hereinabove. Note that the configuration of the card type terminal 2 is not limited to the example illustrated in FIG. 3, and may be, for example, a configuration in which the card type terminal 2 does not include the voice output unit 227 or a configuration in which the card type terminal 2 further includes a light emitting unit such as an an LED or the like as notification means. Furthermore, at least some of functional configurations of the control unit 200 of the card type terminal 2 may be provided in the management server 3.

### 2-2. Configuration of Management Server 3

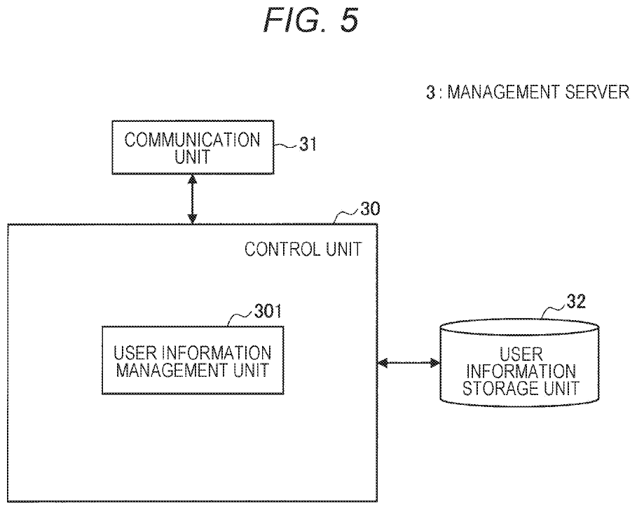

FIG. 5 is a block diagram illustrating an example of a configuration of the management server 3 according to the present embodiment. As illustrated in FIG. 5, the management server 3 includes a control unit 30, a communication unit 31, and a user information storage unit 32.

(Control Unit 30)

The control unit 30 functions as an arithmetic processing device and a control device, and generally controls an operation in the management server 3 according to various programs. The control unit 30 is realized by, for example, an electronic circuit such as a central processing unit (CPU), a microprocessor or the like. Furthermore, the control unit 30 may include a read only memory (ROM) that stores programs, calculation parameters or the like that are used and a random access memory (RAM) that temporarily stores parameters or the like that are appropriately changed.

Furthermore, the control unit 30 according to the present embodiment also functions as a user information management unit 301. The user information management unit 301 stores and manages a user ID, schedule information, an individual ID of the card type terminal 2, and the like, in the user information storage unit 32 as user information. Furthermore, the user information management unit 301 also stores the current position information of the user continuously transmitted from the card type terminal 2 and the information of the current operation mode of the card type terminal 2 in the user information storage unit 32 (may store only the latest information or may store history).

(Communication Unit 31)

The communication unit 31 is connected to a network in a wire or wireless manner and transmits and receives data to and from each card type terminal 2 through the network. The communication unit 31 is communicably connected to the network by, for example, a wired/wireless local area network (LAN), wireless fidelity (Wi-Fi (registered trademark)), or the like.

(User Information Storage Unit 32)

The user information storage unit 32 stores information (user ID, schedule information, individual ID of the card type terminal 2, and the like) regarding the user. Furthermore, the user information storage unit 32 includes a storage medium, a recording device recording data in the storage medium, a reading device reading data from the storage medium, and a storage device including a deleting device deleting data recorded in the storage medium, or the like.

The configuration of the management server 3 according to the present embodiment has been described in detail hereinabove, but the configuration of the management server 3 is not limited to the example illustrated in FIG. 5. For example, the management server 3 may have the processing function of the card type terminal 2 described with reference to FIG. 3 to perform each processing on the basis of the information received from the card type terminal 2. Specifically, for example, the worn state determination unit 201, the authentication unit 202, and the operation mode switching unit 203 of the card type terminal 2 may be provided in the management server 3.

### 3. Operation Processing

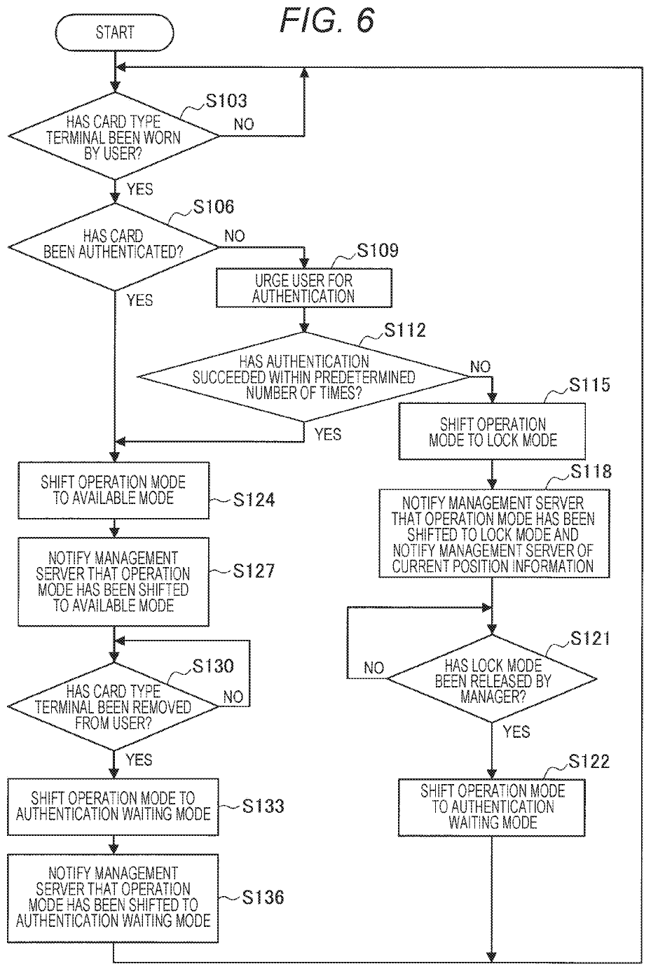

Next, operation mode switching processing of the card type terminal 2 according to the present embodiment will be described in detail with reference to FIG. 6.

FIG. 6 is a flowchart illustrating operation mode switching processing according to the present embodiment. As illustrated in FIG. 6, first, the control unit 200 of the card type terminal 2 determines whether or not the card type terminal 2 is worn by the user by the worn state determination unit 201 (step S103). The worn state determination unit 201 can determine whether or not the card type terminal 2 is in a state in which it is worn by the user on the basis of the detection result detected by the proximity sensor 13 provided in the strap unit 12 and received from the card holder unit 10 to which the card type terminal 2 is mounted.

Next, the control unit 200 of the card type terminal 2 determines whether or not the card type terminal 2 (hereinafter, also referred to as a “card”) has been authenticated (step S106).

Next, in a case where the card type terminal 2 has not been authenticated (step S106/No), the control unit 200 urges the user for authentication (step S109).

Next, in a case where the authentication has not succeeded within a predetermined number of times (step S112/No), the operation mode switching unit 203 shifts the operation mode of the card to the lock mode (step S115).

Next, the state notification control unit 204 notifies the management server 3 that the operation mode has been shifted to the lock mode and notifies the management server 3 of the current position information (step S118).

Next, when the operation mode switching unit 203 receives information indicating that the lock mode has been released by the manager from the management server 3 (step S121), the operation mode switching unit 203 shifts the operation mode of the card type terminal 2 to the authentication waiting mode (step S122).

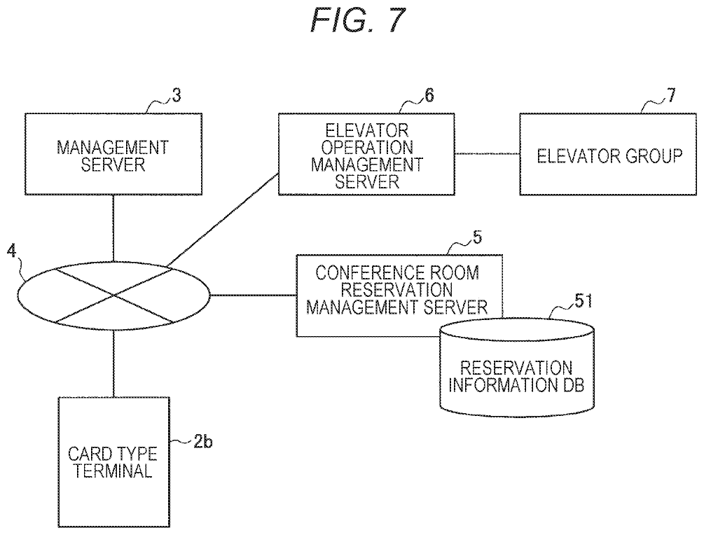

On the other hand, in a case where the card has been authenticated (step S106/Yes) or the authentication has succeeded (step S112/Yes), the operation mode switching unit 203 shifts the operation mode of the card to the available mode (step S124). With this shift, the card type terminal 2 is available. Examples of applications of the card type terminal 2 can include the display of the schedule of the user on the display unit 226, the transmission and reception of the email, the call, the person search, the guidance (navigation) to the next conference room, and the like, as described above. Note that details of route guidance (navigation) performed by the card type terminal 2 will be described later with reference to FIGS. 7 to 12.

Next, the state notification control unit 204 notifies the management server 3 that the operation mode has been shifted to the available mode (step S127). With this notification, the management server 3 can also grasp whether or not the card type terminal 2 is in an available state.

Next, in a case where the card type terminal 2 is removed from the user (in other words, in a case where it is determined by the worn state determination unit 201 that the card type terminal 2 is in a non-worn state) (step S130/Yes), the operation mode switching unit 203 shifts the operation mode of the card to the authentication waiting mode (step S133).

Then, the state notification control unit 204 notifies the management server 3 that the operation mode has been shifted to the authentication waiting mode (step S136).

As described above, in the card type terminal 2 according to the present embodiment, in a state where the card type terminal 2 is worn by the user, the available mode is continued, such that the card can be used, and when the user removes the neck strap device 1 from the neck, such that the card type terminal 2 is in a non-worn state, the operation mode automatically shifts to the authentication waiting mode (unavailable state). With this shift, when the card type terminal 2 has fallen or has been lost, it is possible to prevent the card type terminal 2 from being used by other people, and it is thus possible to enhance safety.

### 4. Navigation System

Next, route guidance (navigation) which is an example of a function of the card type terminal 2 described above will be described in detail with reference to FIGS. 7 to 12. A navigation system according to the present embodiment displays a guidance screen on the card type terminal 2 to guide a user to a destination, and causes an elevator to travel to a riding floor in advance in a case where there is an elevator (an example of a moving object) on a route to the destination, and it is thus possible to reduce a waiting time for the elevator and to further improve convenience in using the moving object.

### 4-1. Entire Configuration

First, an example of the entire configuration of a navigation system including a moving object control according to the present embodiment is illustrated in FIG. 7. As illustrated in FIG. 7, a navigation system according to the present embodiment includes a card type terminal 2b, a management server 3, an elevator operation management server 6, and a conference room reservation management server 5. In the present embodiment, elevator control is performed as an example of moving object control.

The card type terminal 2b is mounted in the neck strap device 1 described with reference to FIG. 1 and is worn by a user.

The elevator operation management server 6 manages and controls an operation of each elevator of an elevator group 7 including one or more elevators installed in an office. Furthermore, the elevator operation management server 6 has a storage unit (not illustrated) that stores a place, a capacity, or the like of each elevator.

The conference room reservation management server 5 registers and manages reservation information of a conference room in the office in a reservation information database (DB) 51. The user can inquire about a vacant situation of the conference room from the conference room reservation management server 5 and arbitrarily reserve a vacant conference room.

### 4-2. Configuration of Card Type Terminal 2b

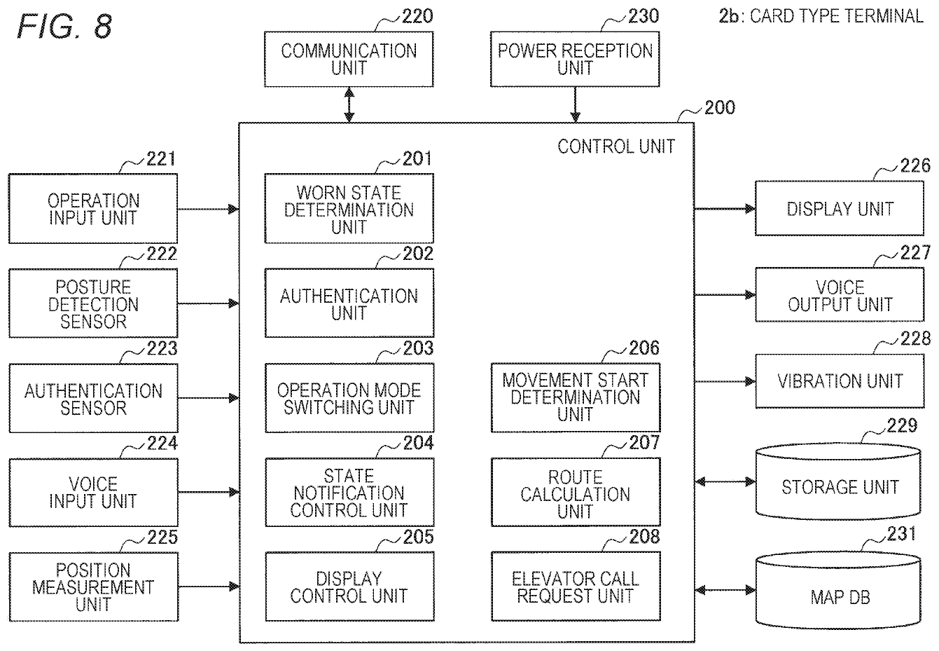

Next, a configuration of the card type terminal 2b used in the navigation system according to the present embodiment will be described with reference to FIG. 8. FIG. 8 is a block diagram illustrating an example of a configuration of the card type terminal 2b used in the navigation system according to the present embodiment.

As illustrated in FIG. 8, the card type terminal 2b includes a control unit 200b, a communication unit 220, an operation input unit 221, a posture detection sensor 222, an authentication sensor 223, a voice input unit 224, a position measurement unit 225, a display unit 226, a voice output unit 227, a vibration unit 228, a storage unit 229, a power reception unit 230, and a map database (DB) 231.

The control unit 200b also functions as a worn state determination unit 201, an authentication unit 202, an operation mode switching unit 203, a state notification control unit 204, a display control unit 205, a movement start determination unit 206, a route calculation unit 207, and an elevator call request unit 208.

The card type terminal 2b according to the present embodiment has a configuration in which it further includes the movement start determination unit 206, the route calculation unit 207, the elevator call request unit 208, and the map DB 231, in addition to the basic configuration described with reference to FIG. 3.

(Movement Start Determination Unit 206)

The movement start determination unit 206 determines whether or not a user has started to move. As a specific method of determining whether or not the user has started to move, a plurality of methods can be considered as follows.

For example, when an absolute position or a relative position (relative position to a reference point) of a wearer in the interior is continuously measured using an acceleration sensor and a gyro sensor or a camera provided in the card type terminal 2 by the position measurement unit 225, the movement start determination unit 206 may determine that the user has started to move in a case where a position change of a predetermined amount or more occurs within a certain time.

Furthermore, when the position measurement unit 225 performs indoor position measurement on the basis of reception intensities of electric waves (such as BLE beacons or the like) received from transmitters whose positions are known, the movement start determination unit 206 may determine that the user has started to move at a point in time when a distance to a transmitter installed at a place through which the user necessarily passes at the time of moving in the vicinity of a door, or the like becomes a predetermined value or less. Alternatively, the movement start determination unit 206 may determine that the user has started to move start in a case where the nearest transmitter changes or may determine that the user has started to move in a case where the measured position changes within a certain time.

Furthermore, the movement start determination unit 206 may continuously measure an acceleration applied to the card type terminal 2b by the acceleration sensor (posture detection sensor 222) and determine that the user has started to move in a case where a pattern of the acceleration coincides with a movement start pattern (at the time of standing up, at the time of walking, or the like) prepared in advance.

Furthermore, the movement start determination unit 206 may perform person recognition by acquiring a captured image captured by a camera (for example, a camera installed in the periphery) installed in an office and determine that the user has started to move in a case where a recognized person is the user and a position of the recognized person is changing. Furthermore, in a case where there is a door that is unlocked by authentication of the card type terminal 2b, the movement start determination unit 206 may determine that the user has started to move when the user passes through the door.

Furthermore, the movement start determination unit 206 may determine that the user has started to move in a case where it can be considered that the user has left his/her seat on the basis of information acquired from a PC of the user. For example, in a case where the PC is locked, there is no operation for a certain period of time, or power is turned off, the movement start determination unit 206 considers that the user has left his/her seat and determines that the user has started to move.

The methods of determining whether or not the user has started to move as described above may be used singly or in combination.

(Route Calculation Unit 207)

When it is determined by the movement start determination unit 206 that the user has started to move, the route calculation unit 207 estimates a movement destination (destination) on the basis of schedule information of the user and calculates a route to the destination. When the route to the destination is calculated, a current position measured by the position measurement unit 225 and map data of the office stored in the map DB 231 are referred to. Furthermore, the route calculation unit 207 may use conference room reservation information as schedule information. In other words, the route calculation unit 207 confirms whether or not the user has reserved a conference room within a predetermined time (for example, within 30 minutes or the like) from a current time from the conference room reservation information stored in the reservation information DB 51 of the conference room reservation management server 5, and estimates that conference room is the destination in a case in which the user has reserved the conference room.

(Elevator Call Request Unit 208)

In a case where an elevator exists on the route calculated by the route calculation unit 207 (that is, in a case of a route for moving to another floor by the elevator), the elevator call request unit 208 requests the elevator operation management server 6 to call the elevator. Specifically, the elevator call request unit 208 transmits the current position of the user, a riding place (riding floor), and a getting-off place (destination floor) to the elevator operation management server 6. Furthermore, the elevator call request unit 208 may calculate an expected arrival time of the user at the riding place (riding floor) and may transmit the expected arrival time together with the current position of the user, the riding place, and the getting-off place.

The elevator operation management server 6 that has received the call request can cause the elevator to travel to a floor designated as the riding floor to make the elevator a standby state before the user arrives at a predetermined elevator hall. Furthermore, in a case where the elevator operation management server 6 also receives the expected arrival time, the elevator operation management server 6 can cause the elevator to travel to the riding floor at the expected arrival time. Note that since the destination floor is also designated, the elevator is controlled to travel to the designated floor by the elevator operation management server 6 without designating the destination floor in the elevator by the user.

(Map DB 231)

The map DB 231 stores, for example, map data of each floor of the office.

The configuration of the card type terminal 2b according to the present embodiment has been described in detail hereinabove.

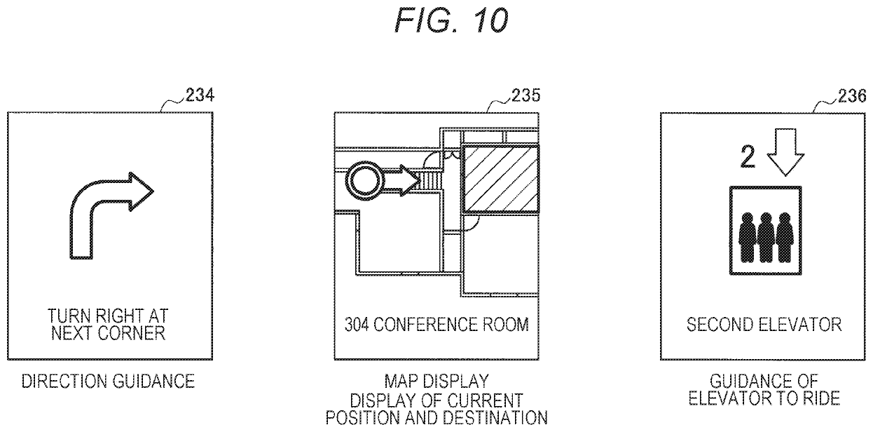

Note that the display control unit 205 according to the present embodiment displays a guidance screen for guiding the user to the destination according to route information calculated by the route calculation unit 207. The guidance screen will be described later with reference to FIG. 10. Furthermore, after the elevator call request, the display control unit 205 may perform notification for informing the display unit 226 of the arrival of the elevator at a point in time when or just before the elevator has arrived at the riding floor, in response to the notification from the elevator operation management server 6.

Furthermore, the elevator operation management server 6 according to the present embodiment can also control the operation of the elevator so that the user can arrive at the destination floor in the shortest time, on the basis of operation information (a current position, a call floor (riding floor), and a destination floor (getting-off floor)) of a plurality of elevator groups (an elevator group for a high floor, an elevator group for a low floor, a north elevator group, a south elevator group, and the like) that are managed and congestion information in an elevator hall or each elevator. A congestion situation of the elevator hall can be grasped by, for example, person recognition by a camera installed in the elevator hall and detection of a person by an infrared temperature sensor. Furthermore, the congestion situation in the elevator can be grasped by person recognition by a camera installed in the elevator, detection of a person by an infrared temperature sensor, or a load (weight) on the elevator. The elevator operation management server 6 estimates, for example, a required time in a case of using each elevator on the basis of the operation information and the congestion information, and guides the user to the elevator for which the required time is the shortest.

The required time in the case of using each elevator is, for example, the sum of the following times, and the elevator operation management server 6 guides the user to the elevator for which the sum of these times is the shortest.
Arrival time at call floor: calculated by adding up stop times at floors at which it is expected that the elevator will stop before the elevator arrives at a call floor of the user on the basis of the current position of the elevator and the numbers of call floors and destination floors by other people. The stop time is estimated from a congestion degree of an elevator hall of a stop floor.

Time required to ride/get off elevator: calculated by inferring the numbers of persons riding the elevator and persons getting off the elevator. The number of persons riding the elevator may be a value obtained by multiplying the congestion degree of the elevator hall by an appropriate ratio based on a ratio of the numbers of upper and lower floors or use prediction. The number of persons getting off the elevator may be a value obtained by multiplying the congestion degree of the elevator by an appropriate ratio based on whether or not the destination floors are set, the number of destination floors, and use prediction.
Possibility of getting in elevator: the predictions of the above two items are recalculated assuming that the next arriving elevator is used in a case where there is a possibility that a person cannot get in the elevator due to excess of a capacity of the elevator in the predictions of the above two items.
Required time to destination floor: calculated on the basis of an elevation time from a riding floor to a getting-off floor and the number of intermediate stop floors. The number of intermediate stop floors is inferred on the basis of the call floors by other people.

Furthermore, the elevator operation management server 6 can also minimize a total of waiting times by collecting elevator call requests from all users and optimizing an operation plan. Specifically, the elevator operation management server 6 can minimize a waiting time and a required time by collecting elevator call requests generated in a certain time frame (within one minute from a current time, or the like) as a target time and optimizing an elevator operation plan as follows. Note that the target time is the future time since there is a time lag based on a movement time from when the elevator call request is made until the user arrives at the elevator hall. Furthermore, in the optimization of the operation plan, an estimate depending on a generation situation of the elevator call request or an inference based on the past history as well as the elevator call request that has been actually generated may be further considered.

Example of Optimization of Operation Plan
Minimize the number of stops of all the elevators by causing the same elevator as much as possible to cope with call requests in which elevation directions and the destination floors of the elevator are the same as each other.
Equalize the number of intermediate stops by distributing call requests to two or more elevators depending on destination floors in a case where the call requests are concentrated.
Move two or more elevators to a floor for which the number of call requests is large.
Distribute locations of elevators upward and downward in a case where congestion is expected in the following time frame.

Furthermore, in a case where the operation plan is optimized and executed, the elevator operation management server 6 ignores a call due to a button operation in the elevator hall, and controls the elevator to stand by at a specific floor or in the vicinity of the specific floor without the call due to the button operation.

Furthermore, in a case where a reservation time (conferencing time) of a conference room is included in the call request, the elevator operation management server 6 may estimate a time required for movement of each user to the destination with reference to the map data of the office and assign the elevator preferentially to a user with the least margin until the conferencing time.

### 4-3. Operation Processing

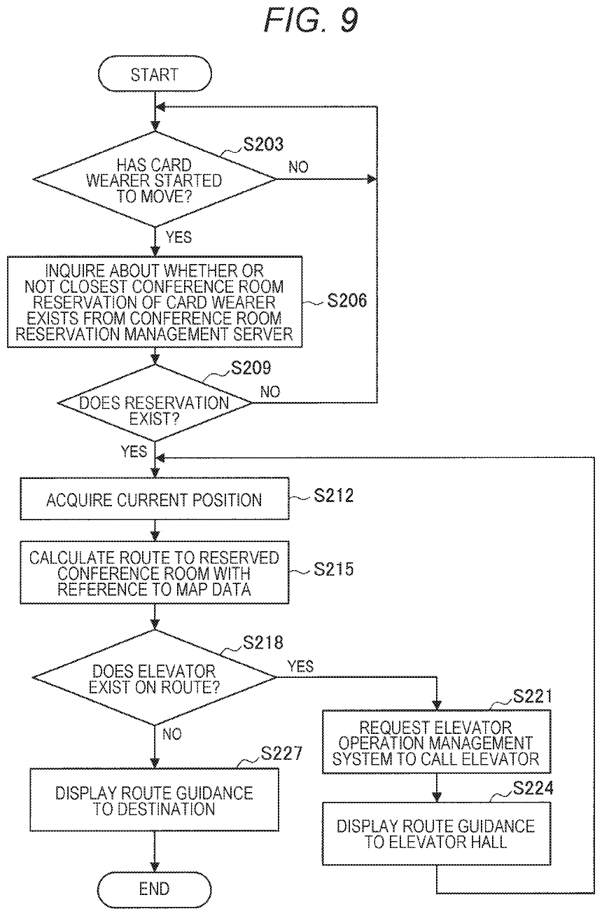

Next, operation processing of the present embodiment will be described with reference to FIG. 9. FIG. 9 is a flowchart illustrating operation processing according to the present embodiment.

As illustrated in FIG. 9, first, in a case where the card type terminal 2b is worn by the user to be in an available mode (see FIG. 4), it is continuously determined by the movement start determination unit 206 whether or not a card wearer (user) has started to move (step S203).

Next, in a case where it is determined that the card wearer has started to move (step S203/Yes), the card type terminal 2b inquires about whether or not the closest conference room reservation (that is, a conference room reservation within a range close to a current time (within 30 minutes or the like)) of the card wearer exists from the conference room reservation management server 5 (step S206).

Next, in a case where the closest conference room reservation exists (step S209/Yes), the card type terminal 2b acquires the current position by the position measurement unit 225 (step S212), and calculates a route to a reserved conference room with reference to the map data of the office registered in the map DB 231 by the route calculation unit 207 (step S215).

Next, in a case where an elevator exists on the route calculated by the route calculation unit 207 (step S218/Yes), the elevator call request unit 208 of the card type terminal 2b requests the elevator operation management server 6 to call the elevator (step S221). The call request includes calculated route information, current position information, reservation information of a conference room, and the like. With this call request, traveling of the elevator is controlled in the elevator operation management server 6, such that a predetermined elevator is in a standby state in the elevator hall, and a waiting time of the user is thus reduced.

Next, the display control unit 205 of the card type terminal 2b displays route guidance to the elevator hall on the basis of the route information calculated by the route calculation unit 207 (step S224).

The above steps S212 to S224 are repeatedly performed, and in a case where the user arrives at the destination floor and the elevator does not exist on the route (step S218/No), the display control unit 205 displays route guidance to the destination (conference room) (step S227).

The operation processing of the navigation system according to the present embodiment has been described in detail hereinabove. Here, an example of a route guidance screen according to the present embodiment is illustrated in FIG. 10. As illustrated in FIG. 10, a direction guidance image 234 indicating an advancing direction by an arrow, a map display image 235 indicating a current position of a user and a destination on a map, or an elevator guidance image 236 indicating an elevator that the user is to ride, or the like, is displayed on the display unit 226 of the card type terminal 2b.

Note that the route guidance is not limited to a method of displaying the route guidance screen on the display unit 226, and may be, for example, guidance by a voice. Furthermore, for example, as illustrated in the left of FIG. 11, direction guidance may be performed by providing a plurality of light emitting units 232a and 232b to a card type terminal 2c and turning on the light emitting units 232a and 232b corresponding to a guiding direction or may be performed by a blinking pattern of light emission or a vibration pattern by the vibration unit 228. Furthermore, as illustrated on the right of FIG. 11, a rotary blade 233 may be provided on a card type terminal 2d to lead a user in a leading direction.

### 4-4. Supplement

Next, some supplementary descriptions for the navigation system according to the present embodiment will be given.

### 4-4-1. Elevator Call Button Attachment

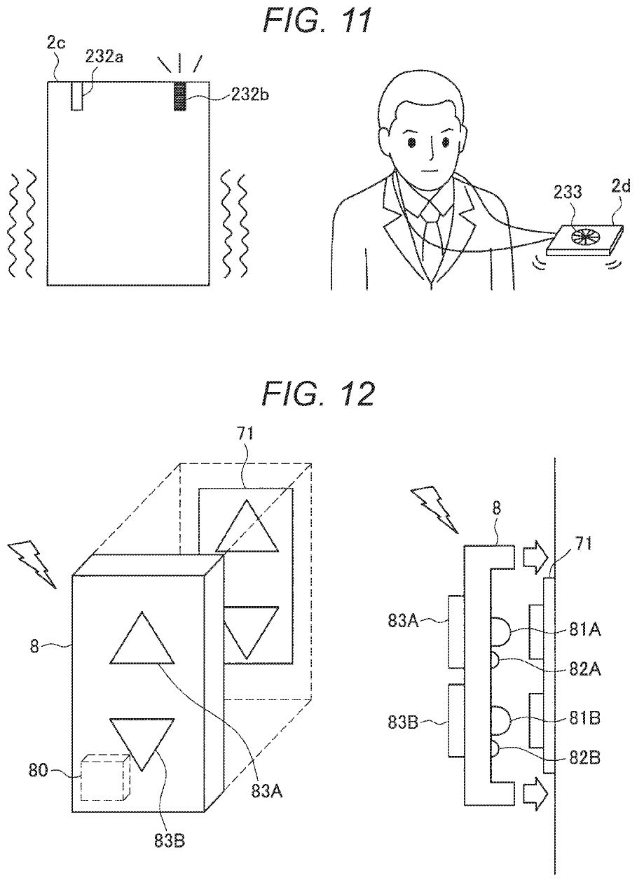

In the embodiment described above, the elevator call request is made from the card type terminal 2b to the elevator operation management server 6 managing the operation of the elevator group 7, but even in a case where there is no elevator travel control system by the elevator operation management server 6, it is also possible to reduce a waiting time by pressing a call button of the elevator by, for example, remote control using an attachment 8 as illustrated in FIG. 12.

The attachment 8 is installed to cover an existing elevator call button 71 as illustrated in FIG. 12, has a communication function, and can press the elevator call button 71 in response to the elevator call request from the card type terminal 2b.

Specifically, the attachment 8 includes a control unit 80, pressing units 81A and 81B that press the existing elevator call button 71, lighting sensors 82A and 82B that detect lighting of the existing elevator call button 71, call buttons 83A and 83B, and a communication unit (not illustrated), as illustrated in FIG. 12.

The pressing units 81A and 81B are driven according to the control of the control unit 80 to press the existing elevator call button 71 (specifically, a call button in an upward direction or a call button in a downward direction).

The lighting sensors 82A and 82B are sensors capable of optically detecting a lighting state of the button, such as photodiodes or the like, and detect the lighting state of the existing elevator call button 71. A detection result is transferred to the control unit 80.

The call buttons 83A and 83B are buttons pressed by a person in the elevator hall instead of the existing elevator call button 71 in a case where he/she wants to call the elevator. In a case where the call button 83A or 83B is pressed, the control unit 80 drives the corresponding pressing unit 81A or 81B to press the existing elevator call button 71.

In a case where the elevator call request is received from the card type terminal 2b, the control unit 80 drives the pressing units 81A and 81B so as to press the call button corresponding to a direction of the destination floor.

Note that the card type terminal 2b transmits a call request to the attachment 8 so as to call the elevator toward the destination floor shortly before the user arrives at the elevator hall. Therefore, the control unit 80 monitors the lighting state of the call button by the lighting sensors 82A and 82B, and continues pressing operation control so that the elevator stays at the elevator hall in a case where the elevator has arrived at the elevator hall but the user has not yet arrived at the elevator hall (for example, until elevator call completion notification is received from the card type terminal 2b).

Furthermore, the communication unit is, for example, Wi-Fi (registered trademark), Bluetooth (registered trademark), a wireless LAN, or the like, and receives the call request from the card type terminal 2b. Note that the communication unit may be a wired communication unit, but since data is wirelessly transmitted from the card type terminal 2b, it is necessary for the data to pass through any wireless communication device.

### 4-4-2. Call Request through Management Server 3

In the elevator system described with reference to FIGS. 7 to 9, the elevator call request is made directly from the card type terminal 2 to the elevator operation management server 6, but the present embodiment is not limited thereto, and the elevator call request may be made to the elevator operation management server 6 through the management server 3 or the management server 3 may confirm the presence or absence of the elevator on the basis of the route information received from the card type terminal 2 and make the elevator call request to the elevator operation management server 6.

Furthermore, the functions of the movement start determination unit 206, the route calculation unit 207, and the elevator call request unit 208 of the card type terminal 2b described with reference to FIG. 8 may be provided in the management server 3.

### 4-4-2. Another Example of Call Target

A call target, which is the moving object existing on the route, is not limited to the elevator, and can be any moving means that can be called.

Specifically, an example of the call target can include a car. The card type terminal 2b can make a call request to a taxi management server, a rental car management server, a car sharing management server, or the like, and can call a moving object to a riding place. With this configuration, it is possible to reduce a waiting time and a moving time and save a time and an effort required for arranging moving means.

### 5. Summary

As described above, in the information processing system according to the embodiment of the present disclosure, it is possible to improve convenience of use of the moving object on the route according to the schedule information of the user.

Hereinabove, the preferred embodiments of the present disclosure have been described in detail with reference to the accompanying drawings, but the present technology is not limited to such embodiments. It will be apparent to those skilled in the art of the present disclosure that various modifications or alterations can be conceived within the scope of the technical idea described in the claims, and it is naturally understood that these modifications or alterations also fall within the technical scope of the present disclosure.

For example, it is also possible to create a computer program for causing hardware such as the CPU, the ROM, the RAM, and the like embedded in the card type terminal 2, the management server 3, or the elevator operation management server 6 described above to exert a function of the card type terminal 2, the management server 3, or the elevator operation management server 6. Furthermore, a computer readable recording medium in which the computer program is stored is also provided.

Furthermore, the effects described in the present specification are only illustrative or exemplary rather than being restrictive. That is, the technology according to the present disclosure can accomplish other effects apparent to those skilled in the art from the description of the present specification, in addition to or instead of the effects described above.

Note that the present technology can also have the following configuration.

(1)

An information processing device including:

a control unit that

determines whether or not a moving object is used on a route to a destination calculated on the basis of a current position and closest schedule information of a user, and

performs control to move the moving object used on the route to a riding place of the user.

(2)

The information processing device according to the above (1),

in which the control unit

predicts an arrival time at the riding place from the current position of the user and the route to the destination, and

instructs an operation management server of the moving object to cause the moving object to stand by at the riding place at the predicted arrival time.

(3)

The information processing device according to the above (1) or (2),

in which the moving object is an elevator, and

the control unit

determines a presence of the elevator on the route, and

instructs an operation management server of the elevator to move the elevator existing on the route to a riding floor of the user.

(4)

The information processing device according to the above (1) or (2),

in which the moving object is a car, and

the control unit

determines whether or not the car is movable on the route, and

instructs a car allocation management server of the car to move the car available on the route to the riding place of the user.

(5)

The information processing device according to any one of the above (1) to (4), in which the control unit performs control to move the moving object used on the route to the riding place in a case where an operation mode of a terminal device worn by the user is an available mode.

(6)

The information processing device according to the above (5),

in which the operation mode of the terminal device

is switched to the available mode in a case of a state where the terminal device is worn by the user, and

is switched to an authentication waiting mode in a case where the terminal device is removed from the user to be in a non-worn state.

(7)

The information processing device according to any one of the above (1) to (6),

in which the closest schedule information is reservation information of a conference room in a range close to a current time, and

the destination is a place of the conference room reserved by the user.

(8)

The information processing device according to any one of the above (1) to (7),

in which the route to the destination is calculated when the user has started to move, and

the control unit outputs guidance information for guiding the user to the destination.

(9)

The information processing device according to any one of the above (1) to (7), further including

a reception unit that receives route information from the current position to the destination from a terminal device worn by the user, the route information being calculated on the basis of the current position and the closest schedule information of the user,

in which the control unit determines whether or not the moving object is used on the route to the destination indicated by the route information.

(10)

The information processing device according to any one of the above (1) to (7),

in which the information processing device is a terminal device worn by the user, and

the control unit

searches for a route from the current position to the destination on the basis of the current position and the closest schedule information of the user.

(11)

The information processing device according to the above (10),

in which the terminal device is a card type terminal device,

the card type terminal device

is attached to or removed from a card holder unit mounted on a strap unit hung on a neck of the user, and

includes a communication unit that communicates with the card holder unit, and

the control unit

determines whether or not the card type terminal device is in a state of being worn by the user on the basis of a detection result detected by a sensor provided in the strap unit and received by the communication unit.

(12)

The information processing device according to the above (11), in which the card type terminal device includes a power reception unit that receives power from the card holder unit.

(13)

The information processing device according to any one of the above (10) to (12),

in which the terminal device further includes a display unit, and

the control unit

performs estimation of the destination and calculation of the route when the user has started to move, and

displays guidance information for guiding the user to the destination on the display unit.

(14)

An information processing method performed by a processor, including:

determining whether or not a moving object is used on a route to a destination calculated on the basis of a current position and closest schedule information of a user; and

performing control to move the moving object used on the route to a riding place of the user.

(15)

An information processing system including:

a server that includes a control unit that determines whether or not a moving object is used on a route to a destination calculated on the basis of a current position and closest schedule information of a user and performs control to move the moving object used on the route to a riding place of the user; and

a terminal device that is worn by the user and includes a route calculation unit that calculates the route from the current position to the destination on the basis of the current position and the closest schedule information of the user,

in which the server further includes a reception unit that receives the calculated route information from the terminal device, and

the control unit determines whether or not the moving object is used on the route to the destination indicated by the route information.

(16)

The information processing system according to the above (15),

in which the terminal device is a card type terminal device,

the card type terminal device

is attached to or removed from a card holder unit mounted on a strap unit hung on a neck of the user, and

further includes

a communication unit that communicates with the card holder unit,

a determination unit that determines whether or not the card type terminal device is worn by the user on the basis of a detection result detected by a sensor provided in the strap unit and received by the communication unit, and

an operation mode switching unit switching an operation mode of the card type terminal device to an available mode in a case of a state where the card type terminal device is worn by the user and switching the operation mode of the card type terminal device to an authentication waiting mode in a case where the card type terminal device is removed from the user, and

the control unit of the server

performs control to move the moving object used on the route to the riding place in a case where the operation mode of the card type terminal device worn by the user is the available mode.

(17)

The information processing system according to the above (15) or (16),

in which the route calculation unit performs estimation of the destination and calculation of the route based on the closest schedule information when the user has started to move, and

the terminal device further includes an output unit that outputs guidance information for guiding the user on the basis of the calculated route information.

### REFERENCE SIGNS LIST

1 Neck strap device
10 Card holder unit
11 Connection unit
12 Strap unit
13 Proximity sensor
2, 2b Card type terminal
200, 200b Control unit
201 Worn state determination unit
202 Authentication unit
203 Operation mode switching unit
204 State notification control unit
205 Display control unit
206 Movement start determination unit
207 Route calculation unit
208 Elevator call request unit
220 Communication unit
221, 221a Operation input unit
222 Posture detection sensor
223 Authentication sensor
224 Voice input unit
225 Position measurement unit
226, 226a Display unit
227 Voice output unit
228 Vibration unit
229 Storage unit
230 Power reception unit
231 Map DB
232a, 232b Light emitting unit
233 Rotary blade
3 Management server
30 Control unit
31 Communication unit
32 User information storage unit
5 Conference room reservation management server
6 Elevator operation management server
7 Elevator group
8 Attachment
80 Control unit
81A Pressing unit
81B Pressing unit
82A Lighting sensor
82B Lighting sensor
83A Call button
83B Call button

1. An information processing device comprising:
a control unit that determines whether or not a moving object is used on a route to a destination calculated on a basis of a current position and closest schedule information of a user; and performs control to move the moving object used on the route to a riding place of the user.

2. The information processing device according to claim 1, wherein the control unit
predicts an arrival time at the riding place from the current position of the user and the route to the destination, and
instructs an operation management server of the moving object to cause the moving object to stand by at the riding place at the predicted arrival time.

3. The information processing device according to claim 1,
wherein the moving object is an elevator, and
the control unit
determines a presence of the elevator on the route, and
instructs an operation management server of the elevator to move the elevator existing on the route to a riding floor of the user.

4. The information processing device according to claim 1,
wherein the moving object is a car, and
the control unit
determines whether or not the car is movable on the route, and
instructs a car allocation management server of the car to move the car available on the route to the riding place of the user.

5. The information processing device according to claim 1, wherein the control unit performs control to move the moving object used on the route to the riding place in a case where an operation mode of a terminal device worn by the user is an available mode.

6. The information processing device according to claim 5,
wherein the operation mode of the terminal device
is switched to the available mode in a case of a state where the terminal device is worn by the user, and
is switched to an authentication waiting mode in a case where the terminal device is removed from the user to be in a non-worn state.

7. The information processing device according to claim 1,
wherein the closest schedule information is reservation information of a conference room in a range close to a current time, and
the destination is a place of the conference room reserved by the user.

8. The information processing device according to claim 1,
wherein the route to the destination is calculated when the user has started to move, and
the control unit outputs guidance information for guiding the user to the destination.

9. The information processing device according to claim 1, further comprising
a reception unit that receives route information from the current position to the destination from a terminal device worn by the user, the route information being calculated on the basis of the current position and the closest schedule information of the user,
wherein the control unit determines whether or not the moving object is used on the route to the destination indicated by the route information.

10. The information processing device according to claim 1,
wherein the information processing device is a terminal device worn by the user, and
the control unit
searches for a route from the current position to the destination on the basis of the current position and the closest schedule information of the user.

11. The information processing device according to claim 10,
wherein the terminal device is a card type terminal device,
the card type terminal device
is attached to or removed from a card holder unit mounted on a strap unit hung on a neck of the user, and
includes a communication unit that communicates with the card holder unit, and
the control unit
determines whether or not the card type terminal device is in a state of being worn by the user on a basis of a detection result detected by a sensor provided in the strap unit and received by the communication unit.

12. The information processing device according to claim 11, wherein the card type terminal device includes a power reception unit that receives power from the card holder unit.

13. The information processing device according to claim 10,
wherein the terminal device further includes a display unit, and
the control unit
performs estimation of the destination and calculation of the route when the user has started to move, and
displays guidance information for guiding the user to the destination on the display unit.

14. An information processing method performed by a processor, comprising:
determining whether or not a moving object is used on a route to a destination calculated on a basis of a current position and closest schedule information of a user; and
performing control to move the moving object used on the route to a riding place of the user.

15. An information processing system comprising:
a server that includes a control unit that determines whether or not a moving object is used on a route to a destination calculated on a basis of a current position and closest schedule information of a user and performs control to move the moving object used on the route to a riding place of the user; and
a terminal device that is worn by the user and includes a route calculation unit that calculates the route from the current position to the destination on the basis of the current position and the closest schedule information of the user,
wherein the server further includes a reception unit that receives the calculated route information from the terminal device, and
the control unit determines whether or not the moving object is used on the route to the destination indicated by the route information.

16. The information processing system according to claim 15,
wherein the terminal device is a card type terminal device,
the card type terminal device is
attached to or removed from a card holder unit mounted on a strap unit hung on a neck of the user, and
further includes
a communication unit that communicates with the card holder unit,
a determination unit that determines whether or not the card type terminal device is worn by the user on a basis of a detection result detected by a sensor provided in the strap unit and received by the communication unit, and
an operation mode switching unit that switches an operation mode of the card type terminal device to an available mode in a case of a state where the card type terminal device is worn by the user and switches the operation mode of the card type terminal device to an authentication waiting mode in a case where the card type terminal device is removed from the user, and
the control unit of the server
performs control to move the moving object used on the route to the riding place in a case where the operation mode of the card type terminal device worn by the user is the available mode.

17. The information processing system according to claim 15,
wherein the route calculation unit performs estimation of the destination and calculation of the route based on the closest schedule information when the user has started to move, and
the terminal device further includes an output unit that outputs guidance information for guiding the user on a basis of the calculated route information.
